(19) United States
(12) Patent Application Publication
(10) Pub. No.: US 2021/0036768 A1
(43) Pub. Date: Feb. 4, 2021

(54) A Method for Implementing Beam Hopping in a Satellite Communications Network

(71) Applicant: SATIXFY ISRAEL Ltd., Rehovot (IL)

(72) Inventors: Arie KESHET, Ramat Efal (IL); Doron RAINISH, Ramat Gan (IL)

(21) Appl. No.: 16/969,082

(22) PCT Filed: Feb. 2, 2019
(86) PCT No.: PCT/IL2019/050168

§ 371 Date: Aug. 11, 2020

Related U.S. Application Data
(60) Provisional application No. 62/629,723, filed on Feb. 13, 2018.
(60) Provisional application No. 62/757,768, filed on Nov. 9, 2018.

(51) Int. Cl. H04B 7/185; H04B 7/204; H04L 5/16

(52) U.S. Cl. CPC H04B 7/18517; H04B 7/18541; H04L 5/16; H04B 7/2041

(57) ABSTRACT

A method is provided for conveying communications within a satellite communication network, by implementing a beam hopping technique for communicating with half-duplex user terminals.

### FIELD OF THE DISCLOSURE

The present disclosure relates to the field of communications and in particularly to communications exchanged between satellite and terrestrial communication terminals/gateways.

### BACKGROUND OF THE DISCLSOURE

Communication satellites in Low Earth Orbit (LEO), circle the earth at a relatively low altitude from 500 to 1500 km. At these altitudes, the orbital period is in the order of 90 to 120 minutes and a satellite is only visible from any location on the ground for just a small period of the time. Furthermore, because of it circles the earth at a relatively low altitude, the satellite's field of view is limited to a few thousand km at the most. For both these reasons, several LEO satellites—a constellation—are used in order to provide continuous communication coverage over a large area. In a typical constellation, several LEO satellites (e.g. 10) are placed at the same orbit at equal distances from each other. Additionally, similar groups of satellites (e.g. 12 in all) are placed each at a separate orbit, with the orbits being displaced from each other to provide optimal overall coverage. The constellation as a whole—120 satellites in this example—can provide a continuous coverage of a large part of the globe by ensuring that at least one satellite is always visible from every location within the coverage area.

To increase their communications capacity and improve signal strength (“link budget”), LEO satellites typically use either multiple antennas or a multi-beam antenna array to illuminate their coverage area by multiple adjoining beams, each serving a ground cell. The RF bandwidth that is available to the satellite is re-used among beams at essentially the same way as in cellular networks.

To optimize bandwidth and transmission power, the ground terminals that communicate with the satellite constellation are divided into two main categories:
a) User terminals, which serve end-users such as remote homes or small businesses. These user terminals are typically small, large in number and are spread across the satellite's coverage area.
b) Gateways, on the other hand, are large earth stations that connect the system to terrestrial networks and eventually to the Internet. They have large capacity and are few in number.

Separate sets of beams are used to connect each satellite to user terminals and gateways. Particularly, there are a small number (e.g. 3) of narrow gateway beams, each configured to illuminate one gateway.

A centralized ground network operations center (NOC) is usually established to control and manage the satellite constellation and gateways. A private terrestrial network connects the NOC to the gateways and—through them—with the satellites.

LEO communication satellites are designed to act as either a relay or a switch. A relaying satellite (a.k.a. a “bent-pipe” satellite) receives signals from ground terminals and transmits them—after filtering, frequency-conversion and amplification—at the same format back to the ground. A switching satellite (a.k.a a regenerative or on-board-processing satellite), on the other hand, relies on a pre-agreed, packetized and addressed format of the ground signal to first demodulate the ground signal and then to route each packet, based on its forwarding address, to one of its transmit beams, where it is modulated onto an appropriate channel for transmission towards the ground.

A relaying satellite provides fixed, pre-configured connections between user beams and gateway beams. A switching satellite provides any-to-any connectivity, with each individual packet being conveyed along a path based on its forwarding address.

Switching satellites are usually equipped with inter-satellite links (ISLs)—being direct radio frequency (RF) or optical links extending between adjacent satellites in the constellation. The ISLs form part of the system's switching fabric and a properly addressed packet can be received from the ground and be routed through multiple satellites before finally transmitted back to the ground anywhere within the constellation's coverage area.

In a switching satellite, each individual user beam operates as a star—or hub-and-spokes—network, with the satellite acting as the network's hub. In such a network, the channel extending from the satellite (hub) to the user terminals (spokes) is called a forward channel, while the channel from the user terminals to the hub is referred to as a return channel. The user-beam network can use the DVB-RCS2 standard for the air interface, enhanced to support LEO-system-specific requirements such as satellite tracking and handover. Gateway beams, on the other hand, are essentially one-to-one duplex connections: DVB-S2X is a common choice for implementing each half of this link.

Multi-beam satellites re-use the available spectrum among user beams in the same way as cellular networks do. In a frequency division (FD) scheme, the spectrum is divided into N (typically four) parts, each of which is used in a sub-set of beams according to an N-color map pattern. Alternatively, with time division (TD) or beam hopping, the entire spectrum is used over one in N cells at a time, changing the illuminated cells in an N-dwell cyclic pattern that is the analog of the N-color map. One of the advantages of beam hopping is the smaller number of receive and transmit chains it uses, leading to cost savings even when taking into consideration the larger bandwidth and higher power that a TD chain requires to keep overall capacity equal to that of an FD system. This advantage becomes even more significant for beams covering low-demand areas: there, the hopping cycle can be extended to more than N dwells, sharing capacity over a larger number of cells, or alternatively allocate different dwell time for each cell, with none of the additional costs that FD would entail in such a scenario.

Beam-forming antenna arrays can be used to cost-effectively create a large number of narrow user beams, thus improving power efficiency and making it possible to use lower-size and therefore lower-cost user terminals. At the same time, the number of concurrent receive and transmit signals is still limited by power and other implementation constraints. Beam hopping can be used to bridge this gap: signals are switched—or hopped—among several antenna beams, in a pattern that matches capacity with traffic demand in the cell covered by each beam dwell.

As explained above, in a switching satellite each individual user beam operates as a star—or hub-and-spokes—network, with the satellite acting as the network's hub: this is called the access network part of the system. The access network typically uses an air interface that complies with the DVB-RCS2 standard. Accordingly, part of the satellite payload acts as the DVB-RCS2 network's hub/NCC, or in short hub.

Multi-beam satellites usually re-use spectrum among user-terminal beams. One way to achieve that is by constant illumination of cells using frequency separation and reuse (“FD”) in a way that is similar to a 2G cellular network. This is shown in FIG. 1A, where a pattern (or “color”) represents another slice of spectrum and polarization configuration orthogonal to the configuration used in other cells, so as not to cause any interference between any two cells. An alternative is to cyclically illuminate subsets (groups) of cells at full bandwidth, as shown in FIG. 1B while maintaining separation within the subset to control interference (“TD”). The full bandwidth illumination is depicted in FIG. 1B by showing all the frequencies (or colors) within a cell. The other cells are illuminated at different time instances. FD and TD have the same theoretical efficiency. A four-color FD map is equivalent to TD with four cell groups, where the bandwidth allocated to each cell in a FD configuration is proportional to the relative dwell time allocated to each cell in a TD configuration.

For low-traffic cells, beam hopping can cost-effectively create less-than-full capacity by using longer (e.g. more than four cell groups) hopping cycles (“sparse” coverage). Beam hopping also makes it possible to easily shift capacity between cells by different dwell times over different cells.

At full capacity, beam hopping must be done in lockstep: the four hops in the cycle are equivalent to the four-color frequency reuse plan (FIG. 2). Sparse coverage must still be synchronized, but there is flexibility in “phase” between groups. In any case the hopping pattern should be planned in advance to avoid intercell interference, equivalently to frequency planning applied to FD.

The advantages of using the beam hopping technique are:

1) Lower cost through a smaller number of transmit and receive channels on board the satellite, especially for sparse coverage;

2) Effective integration of: (i) a large-aperture, beam-forming satellite antenna that can create a large number of beams, with (ii) satellite transmit and receive channels that are limited in number by power and size considerations;

3) Easier implementation of uneven cell capacity; and

4) Easier implementation of make-before-break satellite handover.

Against these advantages associated with the use of the beam hopping technique, the major disadvantages of this technique are increased delay and jitter.

### SUMMARY OF THE DISCLOSURE

Therefore, it is an object of the present disclosure to provide a novel method for carrying out communications between a satellite and terrestrial user terminals/gateways.

It is another object of the present disclosure to provide a novel method that enables beam hopping to serve half-duplex terminals.

Other objects of the present invention will become more apparent from the following detailed description of the invention taken together with the accompanying examples and appended claims.

According to a first embodiment of the present disclosure, there is provided a method for conveying communications within a satellite communication network by implementing a beam hopping technique for the satellite to communicate with half-duplex user terminals.

In accordance with another embodiment, the method comprises implementing a combination of full and sparse beam-hoping patterns.

By yet another embodiment, the method comprises exchanging communications between the satellite and the user terminals by offsetting ground footprint of transmit and receive beams.

According to still another embodiment, the method comprises exchanging communications between the satellite and the user terminals while implementing a progressive time shifting between transmit and receive beam-hopping cycle, and wherein the progressive time shifting is determined for a specific user terminal based on a function of a distance extending between the nadir a that specific user terminal.

In accordance with another embodiment, a number of return channel beams implemented while exchanging communications between the satellite and the user terminals, is higher than a number of forward channel beams.

By yet another embodiment the method provided further comprising a step of implementing a progressive phase shifting between transmit and receive cycles as a function of a distance extending between a cells' group (cycle) and the satellite's nadir.

According to another embodiment, the method further comprising a step of implementing reduction of cycle time by misaligning forward- and return-channel beams.

### BRIEF DESCRIPTION OF THE DRAWINGS

The present invention will be more fully understood from the following detailed description of the embodiments thereof, taken together with the drawings in which:

FIG. 1A—illustrates a prior art configuration where a constant illumination of cells is implemented by using frequency separation and reuse;

FIG. 1B—illustrates another prior art configuration where a cyclical illumination of subsets (groups) of cells at full bandwidth, while maintaining separation within the subset to control interference;

FIG. 2—demonstrates yet another prior art configuration where at full capacity, beam hopping must be done in lockstep. The four hops in a cycle are equivalent to the four-color frequency reuse plan, while sparse coverage must still be synchronized;

FIG. 3—illustrates hotspots or hot areas in partial beam hopping, hotspots or hot areas that according to an embodiment construed in accordance with the present disclosure, may be constantly illuminated, thereby creating a mix of FD and TD;

FIG. 4—demonstrates another embodiment of the present disclosure where half-duplex terminals are used in a hopping beams system;

FIG. 5—demonstrates a case of an embodiment of the disclosure for correcting beam hopping operation serving half-duplex terminals;

FIG. 6A—illustrates an example with a maximal propagation delay of 8.6 msec;

FIG. 6B—illustrates another example depicting a more limited (contiguous) geographical extent of hopping beams than FIG. 6A;

FIG. 7—demonstrates an example of the present disclosure for hopping cycle-time reduction for sparse coverage, wherein cycle time may be reduced by implementing a progressive shifting of the phase between the transmit and receive cycles;

FIG. 8—demonstrates another example of the present disclosure for reducing hopping cycle-time by misaligning forward- and return-channel beams;

FIG. 9—demonstrates still another example of an embodiment construed in accordance with the present disclosure, where the number of return channel beams employed is higher than the number of forward channel beams; and

FIG. 10—demonstrates still another example of an embodiment construed in accordance with the present disclosure, where the return-channel beams are non-hopping beams and a short forward-channel dwells is used. The return-channel capacity is assigned according to a terminal's specific delay, and priority is given to assignments that are more likely to be blocked for most terminals.

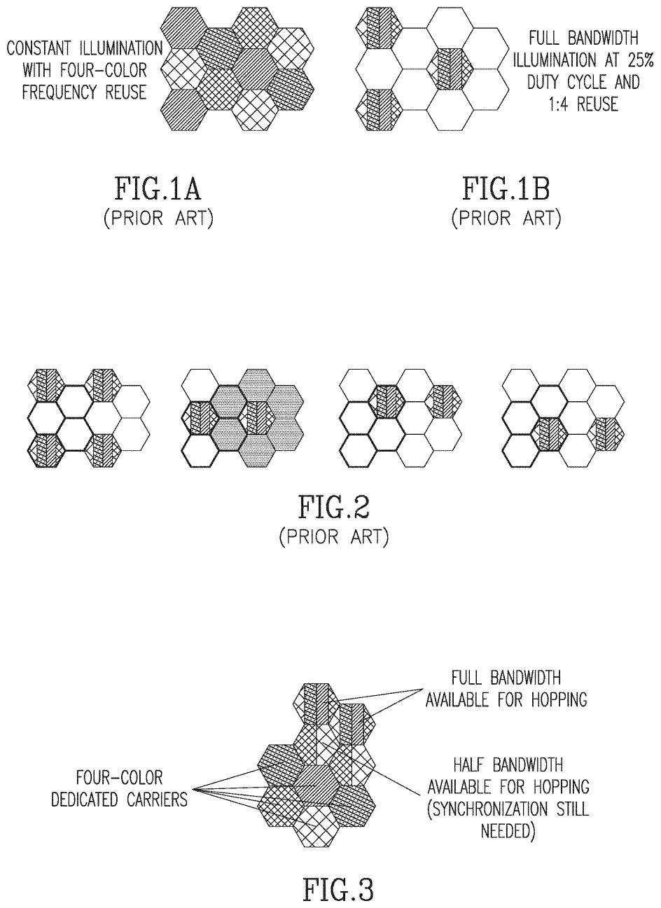

### DETAILED DESCRIPTION OF THE DISCLOSURE

In the following description, for the purposes of explanation, numerous specific details are set forth in order to provide a better understanding of the present invention by way of examples. It should be apparent, however, that the present invention may be practiced without these specific details.

In partial beam hopping, hotspots or hot areas may be constantly illuminated (by non-hopping beams), thereby creating a mix of FD and TD. However, it should be noted that frequency must be coordinated throughout among hopping and non-hopping beams. (FIG. 3).

One option for implementing beam hopping is the following one:
Forward-channel hopping relies on the Super-Frame option of DVB-S2X (Annex E)
   The transmit beam-former and the forward-channel modulator must be synchronized to ensure that Super-Frames are aligned with hops.
DVB-RCS-based return-channel hopping is transparent to the user terminal and is only reflected in capacity assignments
   The DVB-RCS2 MAC at the “NCC” must be aware of hopping timing (i.e. the relation of hop times to the DVB-RCS2 27 MHz master clock).

Obviously, as will be appreciated by those skilled in the art, other methods or other variants may be used, all without departing from the scope of the present invention.

### Half-Duplex User Terminals:

An electronically steered user-terminal antenna, being a major cost consuming element, is more cost-effective when designed for a half-duplex operation (i.e. no reception while transmitting, not necessarily at the same frequency). When implementing the method provided, the following should be taken into consideration:
When serving half-duplex terminals, the forward channel must take into account the unavailability of a terminal to receive communications while it is in transmission mode;
When allocating return-channel resources, the scheduler must leave agreed-upon time intervals during which a terminal is available (free) to receive communications conveyed along the forward channel;
Half-duplex operation reduces the maximum bitrate to and from an individual terminal but does not significantly impact the overall system capacity;
Full-duplex terminals may operate without a change in a system that supports half-duplex operation.

Differential Delay Across Cells

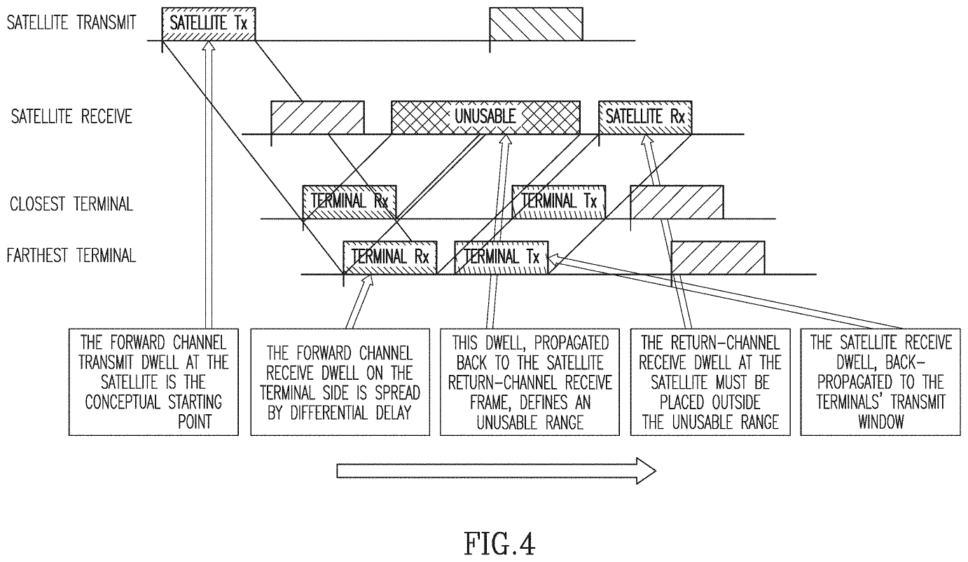

When using half-duplex terminals in a hopping beams system, the hopping cycle for the return channel must be offset from that of the forward channel, in order to prevent receive-transmit overlap at any user terminal. To meet this condition across the service area, differential propagation delay needs to be accounted for (FIG. 4).

For maximum efficiency, all beams must hop in lockstep (the TD equivalent of the four-color scheme). (In sparse coverage, the cycle “phase” may be shifted between cell groups while maintaining synchronicity). This means that at the satellite end of the link the hops are synchronized, while at the user terminal end differential propagation delay accumulates across beam hopping groups. The relevant figure of merit is therefore differential delay across the entire coverage area of the satellite (more precisely, each contiguous area of hopping beams).

For correct beam hopping operation serving half-duplex terminals, the differential propagation delay must be in conformity with the following:

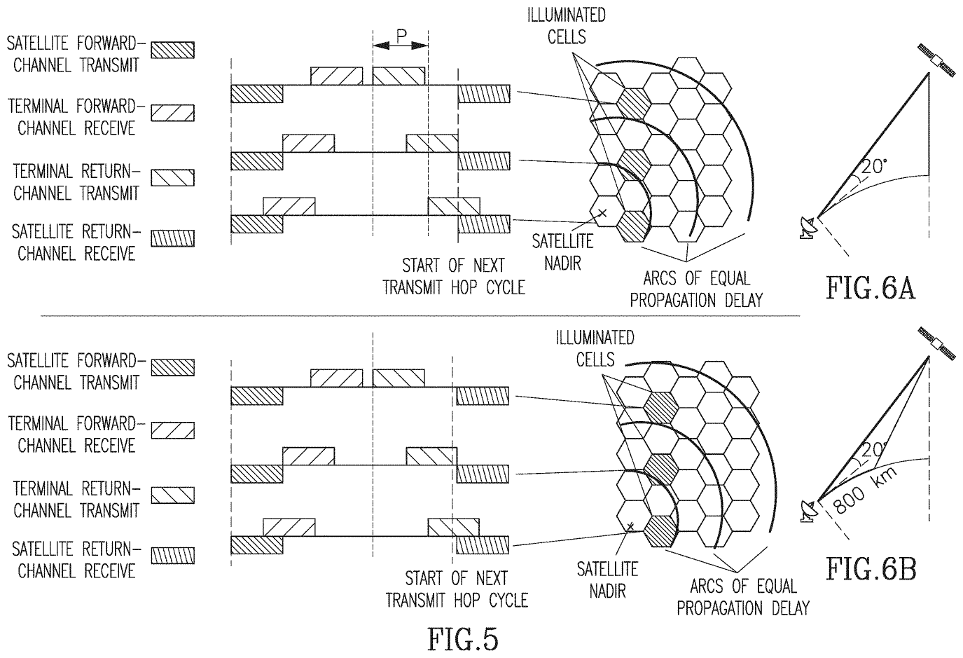

P<(N−2)·D

wherein:
D—is the forward- and return-channel cell dwell time (assumed to be uniform);
N—is the number of cells in the hopping cycle; and
P—is the differential propagation delay. (FIG. 5)

In other words, the hopping cycle, N·D, must accommodate the forward-channel dwell, receive-channel dwell and differential propagation delay (no shifting of cycles is assumed).

Moreover:
1. Differential delay will change as the satellite moves over the coverage area: yet, the inequality must hold for every satellite position.
2. The inequality assumes optimal timing of the forward and receive channel dwells. Particularly, at handover, the relative timing should be set so as to take into account the entire planned path over the coverage area.
3. For non-uniform hopping cycles (i.e. adjoining dense and sparse cycles), the inequality must hold everywhere for the location-specific delay and cycle length.

### Example I (FIG. 6A)

Maximal propagation delay range 8.3-16.9 mS (say 8.6 msec)
   (space-earth-space, 1250 km inclined orbit, nadir to 20° elevation angle)
For an 8-cell cycle, dwell time must be at least 1.4 msec
For the entire cycle—at least 11.4 msec to accommodate the worst-case delay range.

### Example II (FIG. 6B)

For a more limited (contiguous) geographical extent of hopping beams:

| | | |
|---|---|---|
| Beam diameter | 400 | km |
| Limit on downrange distance | 800 | km |
| Maximal differential delay | 4.7 | msec |
| (worst-case is towards edge of coverage) | | |
| Minimal dwell time | 0.78 | msec |
| (8-cell cycle) | | |
| Minimal hopping cycle duration | 6.2 | msec |
| (8-cell cycle) | | |

### Options for Hopping Cycle-Time Reduction

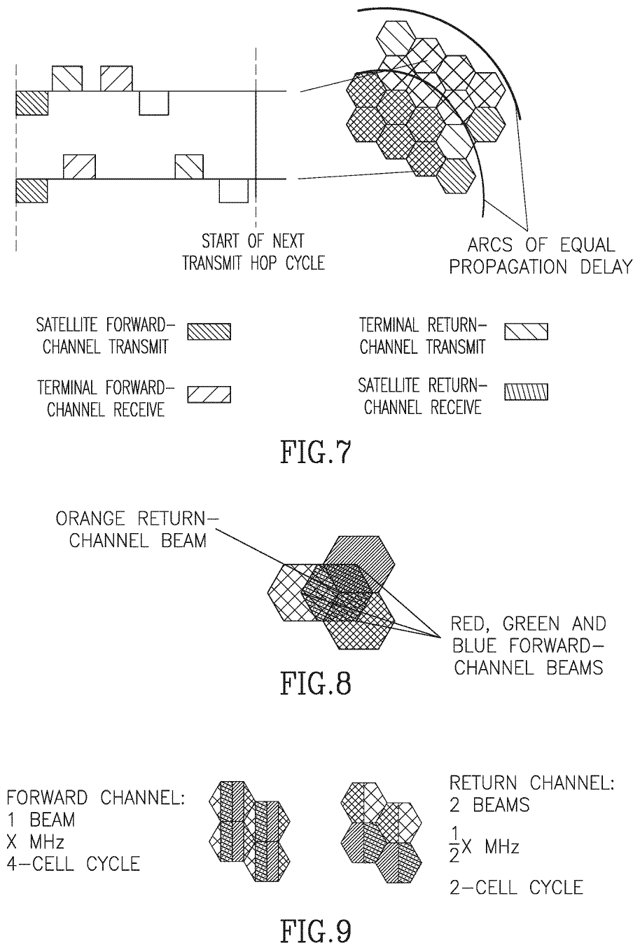

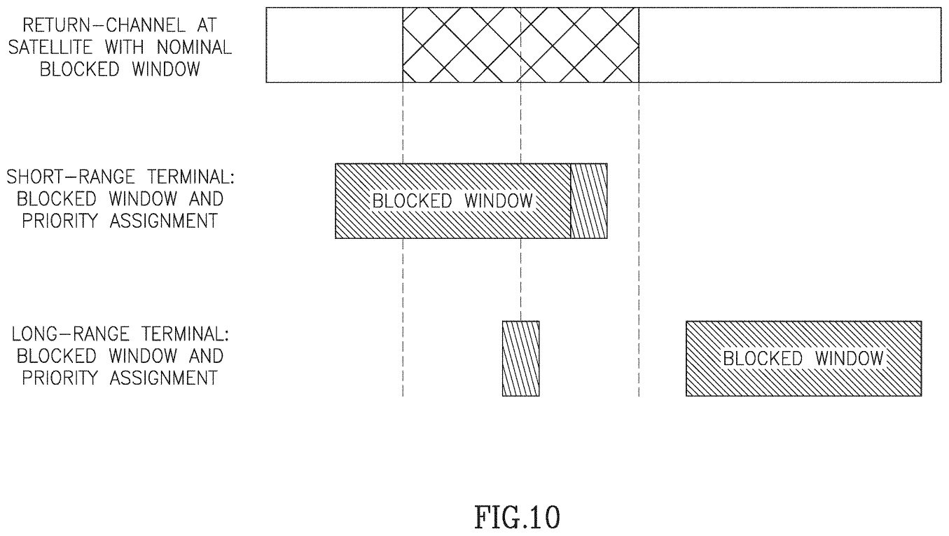

(i) For sparse coverage, cycle time may be reduced by implementing a progressive shifting of the phase between the transmit and receive cycles as a function of the distance of the cell group (cycle) from the satellite nadir. (FIG. 7).
(ii)Misaligning forward- and return-channel beams through one or both of:
   Grid offset (FIG. 8).
   Different transmit and receive beam diameters.
      In FIG. 8, the orange return channel beam serves terminals from three forward channel beams (red, green and blue). If, for example, the return channel controller prioritizes assigning to a terminal in the red beam time slots that are inaccessible by blue- or green-beam terminals, blocking is usually avoided without placing any restrictions on the relative timing of the transmit and receive beams.
      With this scheme, propagation delay is no longer a constraint for the cycle time, but:
   Grid offset may result in a sub-optimal coverage of area edges;
   Alignment of forward- and return-channel capacity is more complex wherever the beam-hopping pattern is non-uniform;
   Staggered handover between satellites requires additional beams to handle borderlines.
(iii) Employ a higher number of return channel beams than the number of forward channel beams. On the average, a return channel beam would have a lower bandwidth and a higher dwell time than that of a forward channel beam. This will guarantee that no terminal is completely blocked. A simple example is illustrated in FIG. 9. The drawback of this scheme is that some return-channel capacity will remain unused. Capacity assignments to each individual terminal should prioritize slots that most likely cannot be used by other terminals (due to propagation delay difference within the cell).
(iv) In a variation of the option described above under (iii), the return-channel beams are non-hopping beams. In principle, for an N-cell hopping cycle on the forward channel, up to 1/N of return channel capacity of each beam might remain unused due to blocking (e.g. 25% for N=4). To reduce and even eliminate this blocking, short forward-channel dwells may be used, e.g. one Super-Frame (0.68 ms at 900 Ms/s). As before, the return-channel capacity may be assigned according to a terminal's specific delay, and priority may be given to assignments that are more likely to be blocked for most terminals (i.e. closer to the center of the blocked interval at nominal, mid-cell delay). Differential delay will “smear” blocking and will allow an almost uniform capacity use wherever the differential propagation delay is of the order of magnitude of the forward channel dwell. (FIG. 10)

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features.

Variations of embodiments of the present invention that are described and embodiments of the present invention comprising different combinations of features noted in the described embodiments will occur to persons of the art. The scope of the invention is limited only by the following claims.

1. A method for conveying communications within a satellite communication network, by implementing a beam hopping technique for communicating with half-duplex user terminals.

2. The method of claim 1, wherein said method comprises implementing a combination of full and sparse beam-hoping patterns.

3. The method of claim 1, wherein said method comprises exchanging communications between the satellite and the user terminals by offsetting ground footprint of transmit and receive beams.

4. The method of claim 1, comprising exchanging communications between the satellite and the user terminals while implementing a progressive time shifting between transmit and receive beam-hopping, and wherein the progressive time shifting for a specific user terminal cell is a function of a distance extending between the nadir and said specific user terminal cell.

5. The method of claim 1, wherein a number of return channel beams implemented while exchanging communications between the satellite and the user terminals, is higher than a number of forward channel beams.

6. The method of claim 1, further comprising a step of implementing a progressive phase shifting between transmit and receive cycles as a function of a distance extending between a cells' group and the satellite's nadir.

7. The method of claim 1, further comprising a step of implementing reduction of cycle time by misaligning forward- and return-channel beams.
